(19) United States
(12) Patent Application Publication
(10) Pub. No.: US 2010/0104264 A1
(43) Pub. Date: Apr. 29, 2010

(54) SYSTEM AND METHOD FOR PLAYING AUDIO FROM A MEDIA SOURCE ON A TELEVISION DURING A MUSIC-ON-MUTE FUNCTION

(75) Inventor: Mark Francis Rumreich, Indianapolis, IN (US)

Correspondence Address: FLETCHER YODER P.C., 7915 FM 1960 RD. WEST, SUITE 330, HOUSTON, TX, 77070, US

(73) Assignee: Shenzhen TCL New Technology LTD, Shenzhen (CN)

(21) Appl. No.: 12/519,503

(22) PCT Filed: Jan. 26, 2007
(86) PCT No.: PCT/US07/02143

§ 371 Date: Jun. 16, 2009

(51) Int. Cl. H04N 5/91; H04N 3/24

(52) U.S. Cl. 386/106; 348/632; 386/E05.003; 348/E03.047

(57) ABSTRACT

There is provided a system and method for playing audio from a media source on a television during a music-on-mute function. More specifically, in one embodiment, there is provided a method, comprising receiving a signal with a video portion and an audio portion, determining whether a music-on-mute function is active, playing the audio portion of the signal if the music-on-mute function is not active, and playing an audio file from an alternative media source if the music-on-mute function is active.

### FIELD OF THE INVENTION

The present invention relates generally to television receivers. More particularly, the present invention relates to a feature of a television that facilitates playing audio from a media source on a television during a music-on-mute function.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Watching television is a very popular pastime in the United States and other countries. However, while a television viewer may enjoy a certain television program, there may be portions or aspects of the program the viewer would choose to avoid. For example, a viewer may wish to silence the program's audio for a time in order to better communicate with a nearby person or to receive a phone call. In another example, the viewer may find it desirable to avoid listening to audio associated with commercials inserted into a particular program. It is a common practice for television programming providers to insert a number of commercial messages from sponsors into program material. Viewers may find these messages irritating. For example, the sound for commercials is frequently louder than the normal television program sound and this can be a source of annoyance.

Many techniques have been devised in an effort to avoid undesirable audio from television programs. One such technique is to provide the television with a mute function, which can be used to silence the program audio. A mute function may be started or stopped by a mute button located on a television remote control. Accordingly, a user may toggle the mute button to silence the sound during a commercial or conversation and then reinitiate the sound when desired by toggling the mute button again. For example, when a commercial starts, a user may press the mute button to turn off the sound from the television and then turn the sound back on by pressing the mute button again when the commercial is over. While this avoids the annoyance of the undesired program audio, it is now recognized that it may create a dull or boring silence, which can also be a source of viewer annoyance.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for playing audio from a media source on a television during a music-on-mute function. More specifically, in one embodiment, there is provided a method, comprising receiving a signal with a video portion and an audio portion, determining whether a music-on-mute function is active, playing the audio portion of the signal if the music-on-mute function is not active, and playing an audio file from an alternative media source if the music-on-mute function is active.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention;

FIG. 2 is a perspective view of a media system in accordance with an exemplary embodiment of the present invention;

FIG. 3 is a process flow diagram representing a procedure for providing a music-on-mute function for a media system in accordance with an exemplary embodiment of the present invention; and

FIG. 4 is a process flow diagram representing another procedure for providing a music-on-mute function for a media system in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

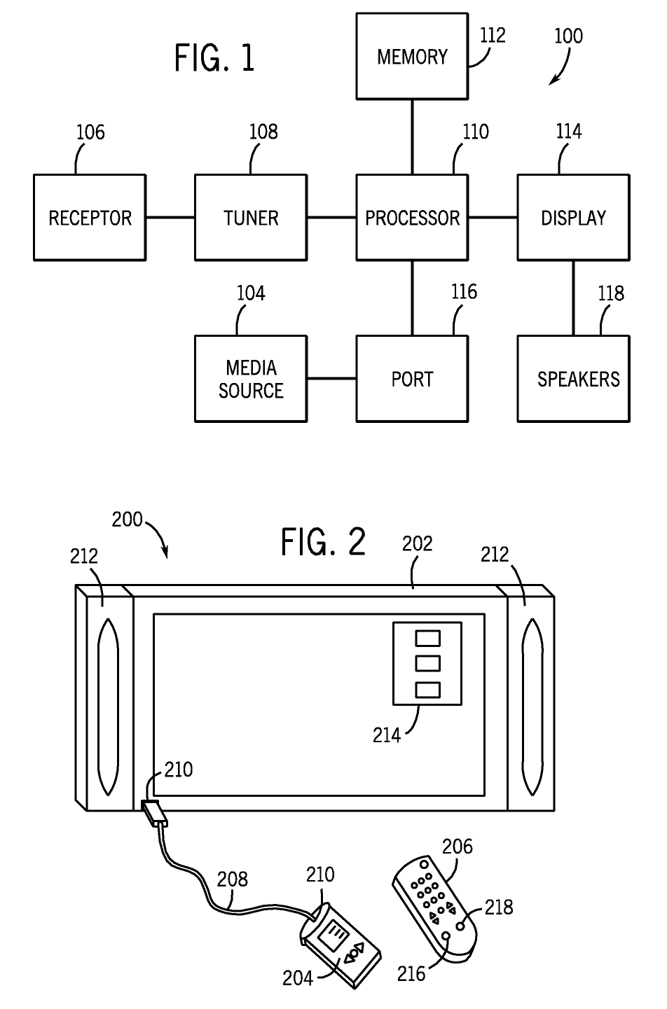

FIG. 1 is a block diagram of an electronic system in accordance with an exemplary embodiment of the present invention. The electronic system is generally indicated by reference numeral 100. The electronic system 100 (e.g., a television) includes a media source 104 (e.g., a portable or built-in digital music player) that may serve as an alternative media source to a standard media signal (e.g., a television broadcast). In other words, the media source 104 may be referred to as an alternative media source. The electronic system 100 further comprises a receptor 106 (e.g., a cable inlet or an antenna), a tuner 108, a processor 110, a memory 112, a display 114, a port 116 (e.g., a universal serial bus port), and speakers 118.

The receptor 106 may be adapted to receive signals (e.g., audio and video) from a provider (e.g., a terrestrial broadcaster or a cable head-end). The tuner 108 may be adapted to facilitate selection of certain provider signals for presentation on the display 114 and over the speakers 118. The memory 112 may be adapted to hold machine-readable computer code that causes the processor 110 to perform an exemplary method in accordance with the present invention. The port 116 may be adapted to communicatively couple with the media source 104 to facilitate communication between the electronic system 100 and the media source 104. The media source 104 may comprise a compact disk (CD) player, a digital video disk (DVD) player, a Moving Picture Expert Group Audio Layer-3 (MP3) player, a Flash memory, satellite radio or the like.

FIG. 2 is a perspective view of a media system in accordance with an exemplary embodiment of the present invention. The media system is generally designated by reference numeral 200. Specifically, the media system 200 includes a television 202, a media source 204, and a remote control 206. In the illustrated embodiment, a cable 208 communicatively couples the television 202 and the media source 204 via communication ports 210 included on each of the television 202 and the media source 204. However, in other embodiments, the media source 204 may communicatively couple with the television 202 in other ways (e.g., wireless communication). For example, the port 210 on the television 202 may be representative of a docking port or cradle adapted to receive and hold the media source 204 in communicative contact with the television 202. This configuration would facilitate communication directly between the ports 210 of the television 202 and the media source 204 without the use of the cable 208. For example, in some embodiments, the media source 204 may include a flash memory that holds stored media files and that couples directly to the television 204. In other embodiments, the media source may be integral to the television receiver, such as a DVD player in a television and DVD player combination package.

The television 202 may include a set of speakers 212 and may be adapted to provide a mute function and/or a music-on-mute function in accordance with present embodiments. The mute function may simply silence the audio output from the television 202 when active. For example, the mute function may operate to completely or substantially prevent the speakers 212 from emitting sound. The music-on-mute function may silence the audio provided with television programming and supplant it with other media from the media source 204. For example, if the music-on-mute function is active during a commercial, it may cause a song (e.g., a song in a previously selected play list) or other audio file stored on the media source 204 to play over the television 202 instead of the audio for the commercial. In other words, the music-on-mute function may simply play audio from the media source 204 over the television 202 instead of audio for the television programming when the music-on-mute function is active.

The music-on-mute function may also cause the television 202 to provide access to media on the media source 204 instead of or in addition to automatically playing an audio file from the media source 204. For example, the music-on-mute function may cause the television 202 to display a menu 214 that allows the viewer to select a desired audio file from the media source 204 to play over the television 202 while the music-on-mute function is active. The menu 214 may also facilitate control of other aspects of the media from the media source 204. For example, a user may be able to control the volume of the audio being played from the media source 204 via the menu 214. It should be noted that the music-on-mute function may not be accessible unless the media source 204 is communicatively coupled (e.g., docked) with the television 202 and suitable media is available in the media source 204.

As set forth above, when the music-on-mute function is active and the television 202 is communicatively coupled with the media source 204, the television 202 may display the menu 214. The menu 214 may facilitate selection of audio tracks from the media source 204 and/or adjusting the audio volume on the television 202 while still displaying the video portion of the television program on the television 202. This allows a viewer to monitor what is going on with the television program while listening to the audio from the media source 204. For example, the viewer may use the music-on-mute function during a commercial and monitor the television program video to determine when the commercial is over so the viewer can deactivate the music-on-mute function to return to playing the audio from the television program. The menu 214 may be navigated using the remote control 206.

The mute and music-on-mute functions may be activated or deactivated by pressing specific buttons on the remote control 206. For example, the mute function may be activated by pressing a mute button 216 and the music-on-mute function may be activated by pressing a music-on-mute button 218. Each function may be deactivated by pressing the corresponding button again. In another example, both the mute function and the music-on-mute function may be linked to the same button. Specifically, for example, the mute function may be activated by pressing the mute button 216 once and the music-on-mute function may be activated by pressing the mute button 216 twice. Further, pressing the mute button 216 a third time may cause the television 202 to resume playing audio associated with the television programming. In other embodiments, the music-on-mute function may be enabled or disabled is other ways (e.g., via a television setup menu or automatically when certain requirements are met).

It should be noted that, in some embodiments, deactivating the music-on-mute function may pause the audio feed from the media source 204, which could then resume where it left off upon reactivating the music-on-mute function. Further, it should be noted that when the music-on-mute function is active, the video may be enhanced (e.g., solarized, colorized, edge detected, or shown as a negative) to indicate that the music-on-mute mode is active. For example, the video may be provided as an audio dependent graphic that is modulated by the beat of audio being played from the media source 204.

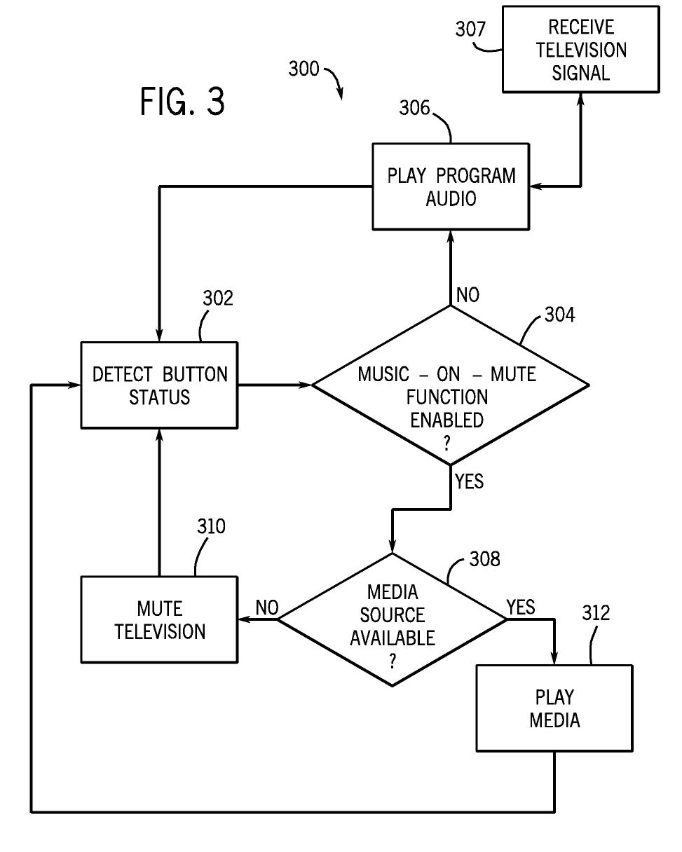

FIG. 3 is a process flow diagram representing a procedure for providing a music-on-mute function for a media system (e.g., a television) in accordance with an exemplary embodiment of the present invention. The procedure may generally be referred to by reference numeral 300. According to procedure 300, in the event that the music-on-mute function is activated and a separate media source is communicatively coupled to the television, television program audio is supplanted by audio from the separate media source. For example, if a viewer activates the music-on-mute function during a commercial, the audio for the commercial will be supplanted by audio stored on the media source until the music-on-mute function is deactivated.

Specifically, the exemplary embodiment illustrated in FIG. 3 includes detecting the status of a music-on-mute button, as illustrated by block 302. It should be noted that in some embodiments a button status may not be utilized. Block 302 may be representative of detecting any type of status that indicates whether the music-on-mute function is enabled or disabled. For example, the status may be stored in a memory. Once the status of the mute button is detected in block 302, it is determined whether the status indicates enablement or disablement of the music-on-mute function, as illustrated in block 304. If the music-on-mute function is not enabled, audio associated with the television programming is played, as indicated by block 306. The audio associated with the program may be received as a component of a television signal, as illustrated by block 307. If the music-on-mute button indicates that the music-on-mute function is active, a determination is made as to whether a separate media source is available, as indicated in block 308. For example, it may be determined whether the media source is communicatively coupled to the television and/or whether the media source is storing any valid media files. If no media source is available, the television may simply be muted, as indicated by block 310. Otherwise, if the media source is available, media from the media source may be played on the television until the music-on-mute function is deactivated, as illustrated by block 312. The process 300 may repeatedly check the status of the button, as illustrated in block 302, to determine whether the music-on-mute function is active or not.

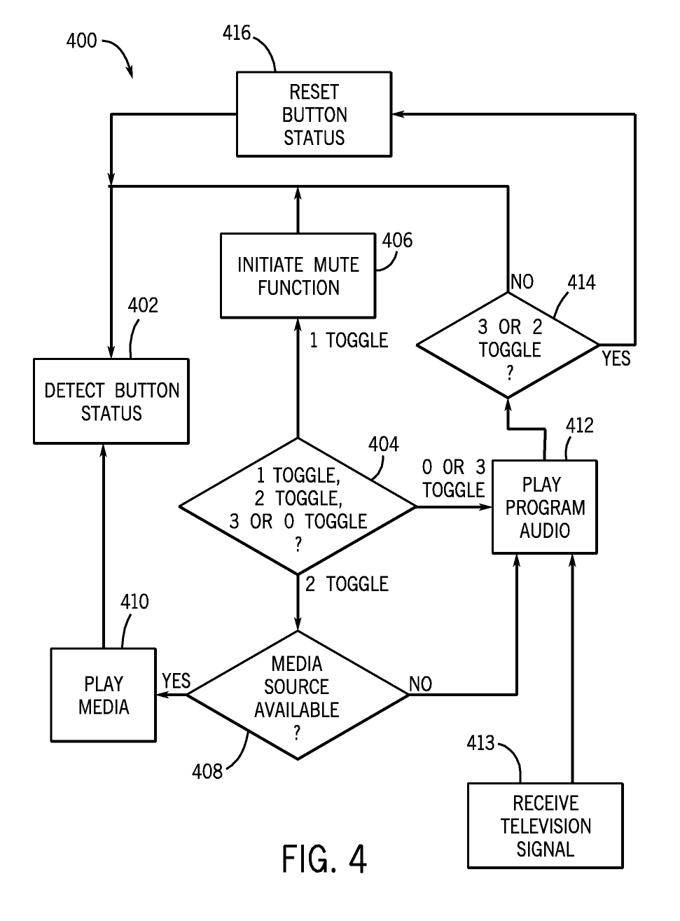

FIG. 4 is a process flow diagram representing another procedure for providing a music-on-mute function for a media system (e.g., a television) in accordance with an exemplary embodiment of the present invention. The procedure may generally be referred to by reference numeral 400. According to exemplary procedure 400, a single button may be utilized to activate a mute function or a music-on-mute function for the media system. The procedure 400 detects button toggles to determine which of three modes to employ. For example, the procedure 400 may continue normal operation, initiate a mute function, or initiate a music-on-mute function depending on a button status (e.g., how many times the button has been successively toggled). In some embodiments, rather than detect a number of toggles, a length of toggle may be detected.

Specifically, the exemplary embodiment illustrated in FIG. 4 includes detecting an operational status (e.g., a button status), as represented by block 402. This may consist of detecting a mode cycled into by activation of a button or a successive number of times the button has been depressed since a reset. Once the status is detected, a determination is made regarding the button status, as represented in block 404. For example, block 404 represents determining whether the button has been toggled zero, one, two, or three times since a reset. This determination may be made using the processor 110 or a function detector component of the processor. In other embodiments, this may represent determining a length of toggle. If the button has been toggled once, a mute function is initiated, as illustrated in block 406. If the button has been toggled twice, a determination is made as to whether a media source is available (e.g., whether an MP3 player has been connected to the television), as illustrated in block 408. If the media source is found to be available in block 408, the procedure 400 proceeds to play media from the media source (i.e., a music-on-mute function), as illustrated by block 410. Otherwise, if no media source is available, the audio for the program is played, as illustrated by block 412. Also, as illustrated by block 412, the audio for the program is played if the button has been toggled three or zero times. The audio may be played by the processor 110 or a play feature of the processor. The audio associated with the program may be received as a component of a television signal, as illustrated by block 413. It should be noted that playing the media source 410 may cause modification of the video output of a system (e.g., solarized, colorized, edge detected, or shown as a negative) to indicate the state of the system.

After the procedure 400 indicates that the program audio should be played (e.g., a normal operation function is active), as illustrated by block 412, it is determined whether the button has been toggled two or three times, as represented by block 414. If it has been toggled two or three times since the last reset, the status of the button is reset to zero toggles, as illustrated by block 416. The process 400 may repeatedly check the status of the button, as illustrated in block 402, to determine whether the mute or music-on-mute function is active or not. It should be noted that in other embodiments, different button status and mode indicators may be utilized. Further, it should be noted that the process 400 may be incorporated with aspects of the process 300 in accordance with present embodiments.

In another embodiment, a single button may be utilized to activate a mute function or a music-on-mute function for the media system by detecting how long the button is toggled (e.g., toggle length). For example, a short press of the button may cause the system to enter a mute state (e.g., a state of silence) and a long press may cause the system to enter a music-on-mute state if music is available (e.g., if an MP3 player is communicatively coupled to the system). The short press may be defined as an activation of the button for a length of time less than a predefined period (e.g., 1 second). The long press may be defined as an activation of the button for a length of time greater than the predefined period (e.g., 1 second). For example a long press may consist of a user holding a button down in the activated position for longer than one second. Accordingly, a short press may consist of the user holding the button down in the activated position for less than one second. Whether the long or short press causes the system to enter a mute state or a music-on-mute state may depend on the existing state of the system. Table 1 describes an exemplary implementation of this embodiment.

TABLE 1

| Current State | Mute Button Action | Resulting State |
|---|---|---|
| TV Audio | Short Press | Mute |
| TV Audio | Long Press | Music (if available) |
| Mute | Short Press | Return to Pre-mute State |
| Mute | Long Press | Return to Pre-mute State |
| Music | Short Press | Mute |
| Music | Long Press | TV Audio |

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method, comprising:
receiving a signal with a video portion and an audio portion;
determining whether a music-on-mute function is active;
playing the audio portion of the signal if the music-on-mute function is not active; and
playing an audio file from an alternative media source if the music-on-mute function is active.

2. The method of claim 1, comprising muting the audio portion if the music-on-mute function is active and the media source is not present.

3. The method of claim 1, comprising playing an MP3 file from the alternative media source if the music-on-mute function is active.

4. The method of claim 1, comprising detecting a button status to determine whether the music-on-mute function is active.

5. The method of claim 4, comprising detecting the button status from a remote control.

6. The method of claim 1, comprising:
determining whether a mute function is active; and
muting the television if the mute function is active.

7. The method of claim 1, comprising muting the television if the music-on-mute function is active and the alternative media source does not provide any audio media.

8. A method comprising:
receiving a television signal with a video portion and an audio portion into a television;
detecting an active function of the television;
playing the audio portion of the television signal on the television if a normal operating function is active; and
muting the audio portion and playing an audio file from a media source on the television if a music-on-mute function is active.

9. The method of claim 8, wherein detecting the active function of the television comprises detecting a toggle status of a button.

10. The method of claim 9, wherein playing the audio file from the media source comprises playing a track from a DVD player that is integral with the television.

11. The method of claim 9, comprising detecting that the button has been toggled for a continuous amount of time less than a predefined time limit.

12. The method of claim 8, comprising muting the television if a mute function is active.

13. The method of claim 12, comprising detecting that a button has been toggled once since a button reset to detect that the mute function is active.

14. The method of claim 8, comprising determining whether the alternative media source is available.

15. The method of claim 8, comprising performing a button reset to set the television to the normal operating function if the television is playing the audio portion and a button has been toggled two or three times since a previous button reset.

16. The method of claim 8, comprising pausing the media source when playing the audio portion of the television signal.

17. A system, comprising:
a receptor configured to receive a signal, the signal comprising a video portion and an audio portion;
a function detector configured to detect an active function;
a play feature configured to play the audio portion of the signal if a normal operating function is active; and
a music-on-mute feature configured to mute the audio portion and play an audio file from an alternative media source if a music-on-mute function is active.

18. The system of claim 17, wherein the function detector is configured to detect a toggle status of a button to detect the active function.

19. The system of claim 17, wherein the music-on-mute feature is configured to provide a menu on a screen of the system to facilitate audio selection.

20. The system of claim 17, wherein the music-on-mute feature is configured to provide a modified video output on a screen of the system when the music-on-mute function is active.
